(19) United States
(12) Patent Application Publication
(10) Pub. No.: US 2008/0126028 A1
(43) Pub. Date: May 29, 2008

(54) Method of reducing a multiple-inputs multiple-outputs (MIMO) interconnect circuit system in a global lanczos algorithm

(75) Inventors: Chia-Chi Chu, Kwei-Shan (TW); Ming-Hong Lai, Kwei-Shan (TW); Wu-Shiung Feng, Kwei-Shan (TW)

Correspondence Address: NIKOLAI & MERSEREAU, P.A., 900 SECOND AVENUE SOUTH, SUITE 820, MINNEAPOLIS, MN, 55402, US

(73) Assignee: Chang Gung University, Kwei Shan (TW)

(21) Appl. No.: 11/527,117

(22) Filed: Sep. 26, 2006

(51) Int. Cl. G06F 17/10

(52) U.S. Cl. 703/2

(57) ABSTRACT

A method of reducing a MIMO interconnect circuit system in a global Lanczos algorithm is used for estimation of the error margin between the original model and the reduced model of MIMO circuit system. In the algorithm, a projection matrix and then a circuit of declining order system are given. A turbulence system being added to the original system, the transfer function union is completely identical to the reduced system union given in the algorithm. It proves that the union of preceding 2q order of the transfer function of reduced system may be surely corresponding to that of original system. It is deduced from the turbulence system added to the original system that the union of preceding 2q order is equal to that of reduced system. In this invention, the algorithm is the basis of determination of the reduced circuit order in a model reduction algorithm a Krylov subspace.

### BACKGROUND OF THE INVENTION

1. Field of the Invention

This invention relates to a method of reducing a multiple-inputs multiple-outputs (MIMO) interconnect circuit system in a global Lanczos algorithm and particularly to a model reduction of a high-speed MIMO interconnect circuit.

2. Description of Related Art

Conventionally, in the process of high-speed development of the semiconductor manufacturing process, the impact caused by the parasitic effect cannot be ignored in the design of interconnection of a high-speed VLSI, such as the prior art on IC Interconnect Analysis proposed in 2002 by M. Celik, L. T. and A. Odabasioglu, Kluwer Academic Publisher.

In order to speed up the flow of a circuit design, the interconnect circuit is generally indicated in a mathematical model for analysis on operating characteristics. Owing to the complexity of a circuit that is gradually going up, in the process of analysis on a result from an emulation, in order to emulate the characteristics of interconnect circuit, the corresponding orders of mathematical model also gradually goes up so that the method of effective model reduction becomes an essential technology for interconnect circuit modeling and simulation.

In the design of VLSI, well known methods of reducing the interconnect circuit model are:
1. method of PVL (Pade via Lanczos), proposed in year 1995 by P. Feldmann and R. W. freund, “Efficient linear circuit analysis by Pad'e approximation via the Lanczos process,” IEEE Trans. on Computer-Aided Design of Integrated Circuits and Systems, Vol. 14pp. 639-649;
2. method of Symmetric PVL (Pade via Lanczos), proposed in year 1997 by P. Feldmann and R. W. freund, “The SyMPVL algorthim and its applications to interconnect simulation,” Proc. 1997 Int. Conf. on Simulation of Semiconductor Process and Devices, pp. 113-116, 1997;
3. method of Arnoldi, applied in “Error Estimations of Arnoldi-Based Interconnect Model-Order Reductions” proposed in year 2005 by C. C. Chu, H. J. Lee and W. S. Feng, IEICE Trans. Fundamentals, Vol. E88-A, No. 2, pp. 533-537, and in “On Projection-Based Algorithms for Model-Order Reduction of Interconnects” proposed in year 2002 by J. M. Wang, C. C. Chu, Q. Yu and E. S. Kuh, IEEE Trans. on Circuit and Systems-I: Fundamental Theory and Applications, Vol. 49, No. 11, pp. 1563-1585; and
4. method of Asymptotic Waveform Evaluation (AWE), proposed in year 1990 by L. T. Pillage and R. A. Rohrer, “Asymptotic waveform evaluation for timing analysis”, IEEE Trans. on Computer-Aided Design of Integrated Circuits and Systems, Vol. 9, No. 4, pp. 352-366.

However, the prior arts mentioned above only deals with the Single Input Single Output (SISO) system; they have not yet dealt with the Multiple Input Multiple Output (MIMO) system.

Thus, a technology of MIMO system model reduction is proposed, comprising:
1. MPVL, “Reduced-Order Modeling of Large Linear Subcircuits via a Block Lanczos Algorithm”, 32nd ACM/IEEE Design Automation Conference, pp. 474-479;
2. Block Arnoldi (BA) algorithm, “Krylov subspace techniques for reduced-order modeling of large-scale dynamical systems”, Appl. Numer. Math., vol. 43, no. 1-2, pp. 9-44, proposed by Z. Bai in year 2002; and “Krylov space methods on state-space control models”, Circuits Syst. Signal Process., vol. 13, no.6, pp. 733-758, proposed by D. L. Boley in year 1994; and “PRIMA: Passive Reduced-Order Interconnect Macromodeling Algorithm”, IEEE Trans. on Computer-Aided Design of Integrated Circuits and Systems, Vol. 17, No. 8, pp. 645-654, proposed by A. Odabasioglu, M. Celik and L. T. Pileggi in year 1998.

However, in the prior art, when the order of reduced system is higher, the value may not be stable; for example, in the iteration process for the MPVL algorithm, breakdown may occur, thereby a preferable breakdown result being not given.

For this reason, in consideration of improvability of the defects described above, this inventor especially concentrates on studies and operate in coordination with academic theories in addition to the experience in this field for many years, finally providing this invention for a design reasonable and effective improvement of the defects mentioned above.

### SUMMARY OF THE INVENTION

In order to solve the above problems, In the conventional design of VLSI, a technology of MIMO system model reduction is well known, comprising MPVL method and Arnoldi (BA) algorithm. However, in the algorithm, when the order of reduced system is higher, the value may not be stable, thereby a preferable breakdown result being not given.

To solve the technical problems, a method of reducing a multiple-inputs multiple-outputs (MIMO) interconnect circuit system in a global Lanczos algorithm is provided, comprising the steps of:
(a) inputting a net-shaped circuit;
(b) inputting a frequency expansion point;
(c) building up a state-space matrix for a circuit;
(d) determining the reduced model order;
(e) generating Frobenius orthonormalization matrix V_{q} and W_{q} in the global Lanczos algorithm;
(f) building up a reduced model system; and
(g) building up a mathematical model for a perturbation system.

Thus, the global Lanczos algorithm is provided in this invention. Steps of vectorizing the matrix are applied in the process of operation, so the same expanded subspaces may still be given and a better breakdown result is given than that in the MPVL algorithm.

For a virtue compared with that of the prior art, a method of reducing a multiple-inputs multiple-outputs (MIMO) interconnect circuit system in a global Lanczos algorithm is provided. In this invention, the steps of vectorizing the matrix are applied in the process of operation, so the same expanded subspaces may still be given, a better breakdown result is given, and improvement of the unstable value occurring when the order of conventional reduced system is higher is made.

However, in the description mentioned above, only the preferred embodiments according to this invention are provided without limit to this invention and the characteristics of this invention; all those skilled in the art without exception should include the equivalent changes and modifications as falling within the true scope and spirit of the present invention.

### BRIEF DESCRIPTION OF THE DRAWINGS

FIG. 1 is a complete flow chart of model reduction of this invention;

FIG. 2 is a view of an embodiment of 12 interconnect lines with 2 inputs and 2 outputs;

FIG. 3 is a view of frequency response of an embodiment of this invention;

FIG. 4 shows the relevant error of a transfer function of the modified model in the MPVL method and the global Lanczos method;

FIG. 5 shows the relevant error caused by the transfer function of reduced model in the global Lanczos method and that of original system additionally provided with the perturbation system; and

FIG. 6 gives a pseudo code for a global Lanczos algorithm.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

In a design of integrated circuit according to this invention, the operation of an interconnect circuit in VLSI is analyzed. Next, the structure of interconnect circuit is extracted, and an objective MIMO interconnect circuit is analyzed, such as a clock signal line, a power line, and a longer bus transmission line. Further, a cluster-based circuit model is constructed, and the parametric expression of cluster-based circuit is used to model the transmission line. A Modified Nodal Analysis matrix is constructed, and the method of Modified Nodal Analysis is applied to construct a math expression of the circuit. Next, a reduced model is constructed, and in a method of reducing a multiple-input-multiple-output (MIMO) interconnect circuit system in a global Lanczos algorithm that is proposed in this invention, a reduced system is constructed and the operation of circuit is analyzed, such as a frequency response waveform of the interconnect circuit. Finally, the simulation of interconnect circuit analysis ends.

In this invention, a method of reducing a multiple-inputs multiple-outputs (MIMO) interconnect circuit system in a global Lanczos algorithm is provided, comprising the steps of:
(a) inputting a net-shaped circuit;
(b) inputting a frequency expansion point;
(c) building up a state-space matrix for a circuit;
(d) determining the reduced model order;
(e) generating Frobenius orthonormalization matrix V_{g,q} and V_{g,q} in the global Lanczos algorithm.

In the process of analysis on the characteristics of a linear interconnect circuit in VLSI, Modified Nodal Analysis (MNA) is applied in the prior art, in which a linear, time-invariant, RLCG interconnect circuit in VLSI may be expressed as the following form:

$$M \frac{d x ( t )}{d t} + Nx ( t ) + Bu ( t ) = 0 , y ( t ) = Lx ( t ) \qquad ( 1 )$$

where a matrix

$$M = [ \begin{matrix}C & 0 \\ 0 & L\end{matrix} ]$$

comprises capacitance C and inductance L in a circuit, a matrix

$$N = [ \begin{matrix}0 & E \\ - {E}^{T} & R\end{matrix} ]$$

comprises resistance R and an incidence matrix E to satisfy Kirchhoff's Voltage Law (KVL) and Kirchhoff's Current Law (KCL), and M,N ε □^{n×n}, B ε □^{n×s} is a matrix determining input node voltage, in which s is a number of input signal and x(t) is a system union function, comprising voltage union and current union, namely

$$x ( t ) = [ \begin{matrix}v ( t ) \\ i ( t )\end{matrix} ] ,$$

and u(t) is a function of system input signal. L ε □^{k×n} To determine an output response matrix and simplify the description, s=k is made in this invention. If A=−(N+s₀M)⁻¹M and R=(N+s₀M)⁻¹B, in which s₀ a frequency expansion point and N+s₀M is non-singular, equation (1) may be changed into:

$$A \frac{d x ( t )}{d t} = x ( t ) + Ru ( t ) and y ( t ) = Lx ( t ) \qquad ( 2 )$$

The transfer functions of original system and simplified system are respectively defined to:

H(s₀+σ)=L(Iₙ−σA)⁻¹R (3)

Ĥ(s₀+σ)=\hat{L}(Iₙ−σÂ)⁻¹\hat{R} (4)

where Â ε □^{q×q} and q<<n.

The global Lanczos algorithm according to this invention is another algorithm of model reduction for the MIMO interconnect circuit, which may be regarded as a standard Lanczos algorithm applied in a matrix to ( ,r) and ( ,r), where ( ,r), ( ,r), and ( ,r). Iₛ ε □^{s×s} is a unit matrix, where \textcircled{×} is the Kronecker product of the two matrices, A=[aᵢⱼ]_{i,j=1}^{m} ε R^{m×m} and B=[bᵢⱼ]_{i,j=1}ⁿ ε R^{n×n}, and the Kronecker product of A and B is made to be A\textcircled{×}B ε R^{mn×mn}, being defined below to:

$$A ⊗ B = [ \begin{matrix}{a}_{11} B & {a}_{12} B & ⋯ & {a}_{1 m} B \\ {a}_{21} B & {a}_{22} B & ⋯ & {a}_{2 m} B \\ ⋮ & ⋮ & ⋮ & ⋮ \\ {a}_{m 1} B & {a}_{m 2} B & ⋯ & {a}_{m m} B\end{matrix} ] = {[ {a}_{ij} B ]}_{i , j = 1}^{m}$$

A vector vec(R) ε R^{ns} is defined to vec(R)=[R(•,1)^{T}, . . . ,R(•,s)^{T}]^{T}, where R(•,j),j=1, . . . , s is a column vector j of R. vec(L^{T}) ε R^{nk} is defined to vec(L^{T})=[L(1,•), . . . ,L(s,•)]^{T}, where L(•,j),j=1, . . . ,k is a raw vector j of L. The relation between the conventional vectorization and the Kronecker product proposed in 1985 by P. Lancaster and M Tismenetsky, The Theory of Matrices: with Applications, Academic Press, pp. 410, is found below:

vec(ABC)=(C^{T}\textcircled{×}A)vec(B).

vec(A)^{T}vec(B)=trace(A^{T}B).

(A\textcircled{×}B)(C\textcircled{×}D)=(AC×BD).

Proposed in this invention, the global Lanczos algorithm is applied to generate Frobenius orthonormalization bases in two Krylov subspaces by means of recursion:

K_{q}(A,R)=span{R,AR, . . . ,A^{q-1}R} and L_{q}(A^{T},L^{T})=span{L^{T},A^{T}L^{T}, . . . ,(A^{T})^{q-1}L^{T}}

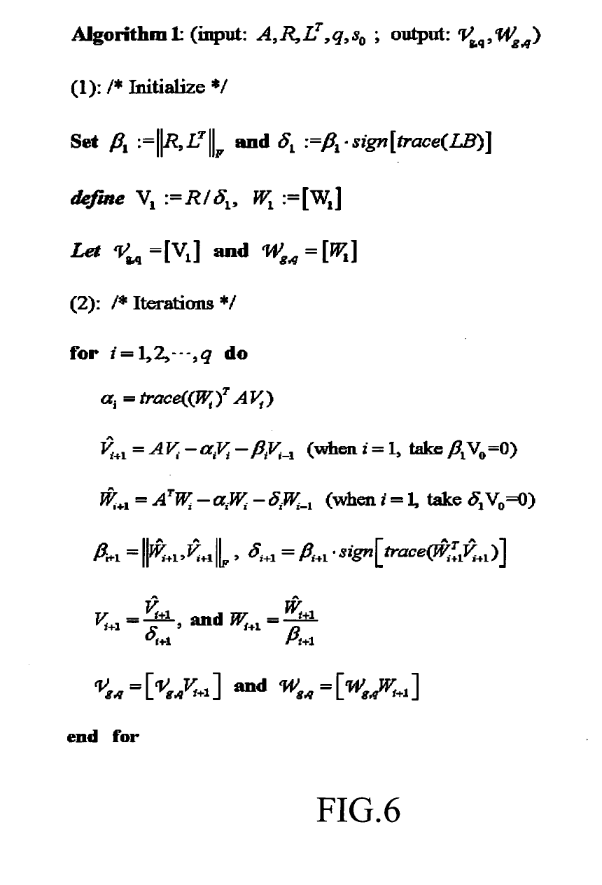

In FIG. 6, the pseudo code in this algorithm is given, in which

$${V}_{1} \frac{L R}{{‖ {L}^{T} , R ‖}_{F}}$$

is an initial matrix, in which <•, •>_{F} is a Frobenius inner product, <A,B>_{F}=trace(A^{T}B).

A Frobenius norm (proposed in 1985 by P. Lancaster and M Tismenetsky, The Theory of Matrices: with Applications, Academic Press) is defined in the prior art to:

∥A,B∥_{F}=\sqrt{|trace(A^{T}B)|}=\sqrt{vec(A)^{T}vec(B)}

From the algorithm proposed in this invention, the Frobenius orthonormalization base may be given, as shown below:

V_{g,q}=[V₁ V₂ . . . V_{q}] ε K_{q}(A,R) and W_{g,q}=[W₁ W₂ . . . W_{q}] ε L_{q}(A^{T},L^{T})

and the following properties are given:

<Vᵢ,Wⱼ>_{F}=0 when i≠j;i,j=1,2, . . . ,q

<Vᵢ,Wⱼ>_{F}=1 when i=j

and V_{g,q} is made to be a matrix V_{g,q}, V_{g,q}, and V_{g,q} is a matrix V_{g,q}, V_{g,q}. T_{g,q} is a triangle matrix q×q:

$${T}_{g , q} = [ \begin{matrix}{α}_{1} & {β}_{2} & & & \\ {δ}_{2} & {α}_{2} & {β}_{3} & & \\ & {δ}_{3} & {α}_{3} & ⋰ & \\ & & ⋰ & ⋰ & {β}_{q} \\ & & & {δ}_{q} & {α}_{q}\end{matrix} ]$$

The Kronecker product \textcircled{×} is used to satisfy the following relation:

AV_{g,q}=V_{g,q}\tilde{T}_{g,q}+δ_{q+1}V_{q+1}E_{q}^{T} (5)

A^{T}W_{g,q}=W_{g,q}\tilde{T}_{g,q}^{T}+β_{q-1}W_{q+1}E_{q}^{T} (6)

\tilde{T}_{g,q}=T_{g,q}\textcircled{×}Iₛ, where Iₛ is a unit matrix of dimension s.

Eⱼ=eⱼ\textcircled{×}Iₛ, where eⱼ is a column vector j of the unit matrix.

The Dimension of Eⱼ is identical to those of other matrices, but what is different from the standard Lanczos algorithm is the product of W_{g,q}^{T}V_{g,q} is not a unit matrix but a unit matrix of vec(W_{g,q}^{T})vec(V_{g,q}).
(f) building up a reduced model system;

In this invention, a reduced model in the global Lanczos algorithm is proposed to generate two projection matrices V_{g,q} and W_{g,q} in an asymmetric, global Padé via Lanczos algorithm.

In case of \tilde{W}_{g,q}=W_{g,q}(W_{g,q}^{T}V_{g,q})^{-T}, the simplified system is defined to:

Â=\tilde{W}_{g,q}^{T}AV_{g,q}, \hat{R}=\tilde{W}_{g,q}^{T}R=δ₁E₁, and \hat{L}=LV_{g,q}=β₁E₁^{T}W_{g,q}^{T}V_{g,q} (7)

The product of \tilde{W}_{g,q}^{T}V_{g,q} is a unit matrix, in which \tilde{W}_{g,q}^{T} may be regarded as a pseudo-inverse matrix of V_{g,q} and may be expressed as V_{g,q}⁺, so the matrix V_{g,q}V_{g,q}⁺ may be regarded as a projection matrix projected to a column space V_{g,q}.

Further, V_{g,q}, W_{g,q}, are T_{g,q} generated after q times of iteration in the global Lanczos algorithm; from the characteristics mentioned above, the characteristic of matching may prove.

For declining order system i-th, where i=0,1, . . . ,2q−1, the system union is described below.

In case of i=0, i=0, i=0 is a projection matrix in the i=0 column vector and i=0, so i=0, i=0 is established in case of i=0; supposing that i=0, i=0 is established. In case of i=k+1, then

$$\begin{matrix}{L}^{⋒} {{A}^{⋒}}^{k + 1} {R}^{⋒} = L {{𝒱}_{g , q} ( {\tilde{𝒲}}_{g , q}^{T} A {𝒱}_{g , q} )}^{k} {\tilde{𝒲}}_{g , q}^{T} A {𝒱}_{g , q} {\tilde{𝒲}}_{g , q}^{T} R \\ = L {{𝒱}_{g , q} ( {\tilde{𝒲}}_{g , q}^{T} A {𝒱}_{g , q} )}^{k} {\tilde{𝒲}}_{g , q}^{T} A R\end{matrix}$$

AR exists in colspan{V_{g,q}}, so V_{g,q}\tilde{W}_{g,q}^{T}AR=AR. Thus, \hat{L}A^{k+1}\hat{R}=LA^{k+1}R. It thus proves that the union matching property of the preceding 2q orders of the original system and reduced system is established.

In this invention, a math expression of the preceding 2q orders of the original system and reduced system is also proposed. In the definition given from equation (5) in the global Lanczos algorithm, if Δ₁′=δ_{q+1}V_{q+1}E_{q}^{T} is defined, in case of k=0,1, . . . ,q−1 then

$${A}^{k} {𝒱}_{g , q} = {𝒱}_{g , q} {T}_{g , q}^{k} {\sum }_{i = 1}^{k} {A}^{i - 1} {Δ}_{i}^{′} {\tilde{T}}_{g , q}^{k - i} \qquad ( 8 )$$

Likewise, if Δ₂′=β_{q+1}W_{q+1}E_{q}^{T} is defined, then

$${( {A}^{T} )}^{k} {𝒲}_{g , q} = {{𝒲}_{g , q} ( {\tilde{T}}_{g , q}^{T} )}^{k} + {\sum }_{i = 1}^{k} {( {A}^{T} )}^{i - 1} {Δ}_{2}^{′} {\tilde{T}}_{g , q}^{k - i} \qquad ( 9 )$$

E₁ is multiplied respectively at the right sides of equations (8) and (9), and then

$$\begin{matrix}{A}^{k} {𝒱}_{g , q} {E}_{1} = {𝒱}_{g , q} {\tilde{T}}_{g , q}^{k} {E}_{1} + {\sum }_{i = 1}^{k} {A}^{i - 1} {Δ}_{1}^{′} {\tilde{T}}_{g , q}^{k - i} {E}_{1} & ( 10 ) \\ {( {A}^{T} )}^{k} {𝒲}_{g , q} {E}_{1} = {𝒲 ( {\tilde{T}}^{T} )}^{k} {E}_{1} + {\sum }_{i = 1}^{k} {( {A}^{T} )}^{i - 1} {{Δ}_{2}^{′} ( {\tilde{T}}_{g , q}^{T} )}^{k - i} {E}_{1} & ( 11 )\end{matrix}$$

where after q times of iteration in the global Lanczos algorithm, a result is given as follows:

$${E}_{1} {\tilde{T}}_{g , q}^{i} {E}_{q} = \{ \begin{matrix}0 , & 0 \leq i < q - 1 \\ {β}_{2} {β}_{3} ⋯ {β}_{q} {I}_{s} , & i = q - 1\end{matrix} \\ and \\ {E}_{q}^{T} {\tilde{T}}_{g , q}^{j} {E}_{1} = \{ \begin{matrix}0 , & 0 \leq j < q - 1 \\ {δ}_{2} {δ}_{3} ⋯ {δ}_{q} {I}_{s} , & j = q - 1\end{matrix}$$

Thus, in case of i<q−1, equations (10) and (11) may be reduced to:

AⁱV_{g,q}E₁=V_{g,q}\tilde{T}_{g,q}ⁱE₁ and (A^{T})ⁱW_{g,q}E₁=W_{g,q}(\tilde{T}_{g,q}^{T})ⁱE₁.

In case of i=q−1, then

$$\begin{matrix}{A}^{q} {𝒱}_{g , q} {E}_{1} = {𝒱}_{g , q} {\tilde{T}}_{g , q}^{q} {E}_{1} + {Δ}_{1}^{′} {\tilde{T}}_{g , q}^{q - 1} {E}_{1} \\ = {𝒱}_{g , q} {\tilde{T}}_{g , q}^{q} {E}_{1} + {δ}_{q + 1} {𝒱}_{q + 1} {E}_{q}^{T} {\tilde{T}}_{g , q}^{q - 1} {E}_{1} \\ = {𝒱}_{g , q} {\tilde{T}}_{g , q}^{q} {E}_{1} + ( {δ}_{2} {δ}_{3} ⋯ {δ}_{q + 1} ) {V}_{q + 1}\end{matrix}$$

$$\begin{matrix}{( {A}^{T} )}^{q} {𝒲}_{g , q} {E}_{1} = {{𝒲}_{g , q} ( {\tilde{T}}_{g , q}^{T} )}^{q} {E}_{1} + {{Δ}_{2}^{′} ( {\tilde{T}}_{g , q}^{T} )}^{q - 1} {E}_{1} \\ = {{𝒲}_{g , q} ( {\tilde{T}}_{g , q}^{T} )}^{j} {E}_{1} + {β}_{q + 1} {W}_{q + 1} {E}_{q}^{T} {\tilde{T}}_{g , q}^{q - 1} {E}_{1} \\ = {{𝒲}_{g , q} ( {\tilde{T}}_{g , q}^{T} )}^{q} {E}_{1} + ( {β}_{2} {β}_{2} ⋯ {β}_{q + 1} ) {W}_{q + 1}\end{matrix}$$

Thus,

LA^{2q}R=LA^{q}A^{q}R=β₁E₁^{T}W_{g,q}^{T}A^{2q}V_{g,q}E₁δ₁=β₁(E₁^{T}\tilde{T}_{g,q}^{q}W_{g,q}^{T}+(β₂β₃ . . . β_{q+1})W_{q+1}^{T})(V_{g,q}\tilde{T}_{g,q}^{q}E₁+(δ₂δ₃ . . . δ_{q+1})V_{q+1})δ₁=β₁E₁^{T}\tilde{T}_{g,q}^{q}W_{g,q}^{T}V_{g,q}\tilde{T}_{g,q}^{q}E₁δ₁+(β₁β₁ . . . β_{q+1}δ₁δ₂ . . . δ_{q+1})W_{q+1}^{T}V_{q+1}+β₁(δ₁δ₂δ₂ . . . δ_{q+1})E₁^{T}\tilde{T}_{g,q}^{q}W_{g,q}^{T}V_{q+1}+δ₁(β₁β₂β₂ . . . β_{q+1})W_{q+1}^{T}V_{g,q}\tilde{T}_{g,q}^{q}E (12)

where the last three items may be regarded as an error between the original system and the reduced system of order 2q.

In the global Lanczos algorithm, another simplified system is proposed in this invention, and the simplified system defines the declining system of order q to Â=W_{g,q}^{T}A\tilde{V}_{g,q}, where \tilde{V}_{g,q}=V_{g,q}(W_{g,q}^{T}V^{g,q})⁻¹. Likewise, the product of W_{g,q}^{T}\tilde{V}_{g,q} is also a unit matrix. Thus, the union matching property is still applicable; namely in case of j=0,1, . . . ,2q−1, j=0,1, . . . ,2q−1.
(g) building up a mathematical model for a perturbation system.

Among many model reduction arts, a prior art is proposed on April 1995 by I. M. Jaimoukha and E. M. Kasenally “Oblique Projection Methods for Large Scale Model Reduction” Siam J. Matrix Anal. Appl. Vol. 16, No. 2, pp. 602-627 for application of a Lyapunov equation as a mathematical model,

AP+PA^{T}+RR^{T}=0 (13)

A^{T}Q+QA+L^{T}L=0 (14)

If λᵢ is a eigenvalue i of matrix A, for all i,j, in case of λᵢ(A)+ λ̅ⱼ(A)≠0 provided with unique symmetry, λ̅ⱼ(A) represents a conjugate compound radical of λⱼ(A).

P* is made to be a precise solution to equation (13) and Q* is made to be that to equation (14); in this invention, an approximate solution P* is proposed, of which the form is P_{q}=V_{g,q}X_{q}V_{g,q}^{T}, where X_{q} ε □^{q×q} is a randomly symmetric matrix and V_{g,q} is an orthonormalization base of K_{q}(A,B). Likewise for equation (14), an approximate solution of Q* is made to be Q_{q}=W_{g,q}Y_{q}W_{g,q}^{T}, where W_{g,q} is a combination of orthonormalization bases in the Krylov subspace L_{q}(A^{T},L^{T}) of dimension.

Further, this invention follows the prior art proposed on April 1995 by I. M. Jaimoukha and E. M. Kasenally “Oblique Projection Methods for Large Scale Model Reduction” Siam J. Matrix Anal. Appl. Vol. 16, No. 2, pp. 602-627, and an equation of residual error is defined so that results are given as follows from the X_{q} and X_{q}:

R_{q}(X_{q}):=A(V_{g,q}X_{q}V_{g,q}^{T})+(V_{g,q}X_{q}V_{g,q}^{T})A^{T}+BB^{T} (15)

S_{q}(Y_{q}):=A^{T}(W_{g,q}Y_{q}W_{g,q}^{T})+(W_{g,q}Y_{q}W_{g,q}^{T})A+LL^{T} (16)

From equations (5) and (6), the sets of definition are given as follows:

\tilde{H}_{q}=(W_{g,q}^{T}V_{g,q})⁻¹W_{g,q}^{T}AV_{g,q}=\tilde{T}_{g,q}+(W_{g,q}^{T}V_{g,q})⁻¹W_{g,q}^{T}V_{q+1}δ_{q+1}E_{q}^{T}

\tilde{G}_{q}=W_{g,q}^{T}AV_{g,q}(W_{g,q}^{T}V_{g,q}⁻¹=\tilde{T}_{g,q}+E_{q}β_{q+1}W_{q+1}^{T}V_{q+1}(W_{g,q}^{T}V_{g,q})⁻¹

After substitution of equation (15) into equation (13), a result is given:

$$\begin{matrix}\begin{matrix}{R}_{q} ( {X}_{q} ) = \text{[} {𝒱}_{g , q} \text{(} I - {𝒱}_{g , q} \text{(} {𝒲}_{g , q}^{T} {𝒱}_{g , q} {)}^{- 1} {𝒲}_{g , q}^{T} ) {V}_{q + 1} \text{]} \times \\ [ \begin{matrix}{\tilde{H}}_{q} {X}_{q} + {X}_{q} {\tilde{H}}_{q}^{T} + {E}_{1} {β}_{1}^{2} {E}_{1}^{T} & {X}_{q} {E}_{q} {δ}_{q + 1} \\ {δ}_{q + 1} {E}_{q}^{T} {X}_{q} & 0\end{matrix} ]\end{matrix} \\ [ \begin{matrix}{𝒱}_{g , q}^{T} \\ {V}_{q + 1}^{T} ( I - {{𝒲}_{g , q} ( {𝒱}_{g , q}^{T} {𝒲}_{g , q} )}^{- 1} {𝒱}_{g , q}^{T} )\end{matrix} ]\end{matrix} \qquad ( 17 )$$

After substitution of equation (16) into equation (14), a result is given:

$$\begin{matrix}\begin{matrix}{S}_{q} ( {Y}_{q} ) = [ {𝒲}_{g , q} ( I - {{𝒲}_{g , q} ( {𝒱}_{g , q}^{T} {𝒲}_{g , q} )}^{- 1} {𝒱}_{g , q}^{T} ) {W}_{q + 1} ] \times \\ [ \begin{matrix}{{G}^{⋒}}_{q}^{T} {Y}_{q} + {Y}_{q} {{G}^{⋒}}_{q} + {E}_{1} {β}_{1}^{2} {E}_{1}^{T} & {Y}_{q} {E}_{q} {β}_{q + 1} \\ {β}_{q + 1} {E}_{q}^{T} {Y}_{q} & 0\end{matrix} ]\end{matrix} \\ [ \begin{matrix}{𝒲}_{g , q}^{T} \\ {W}_{q + 1}^{T} ( I - {{𝒱}_{g , q} ( {𝒲}_{g , q}^{T} {𝒱}_{g , q} )}^{- 1} {𝒲}_{g , q}^{T} )\end{matrix} ]\end{matrix} \qquad ( 18 )$$

Supposing q times of global Lanczos algorithm is done, P_{q}=V_{g,q}X*_{q}V_{g,q}^{T}, Q_{q}=W_{g,q}Y*_{q}W_{g,q}^{T} is a low-order approximate solution to equations (13) and (14) and X*_{q} and Y*_{q} satisfy equations (19) and (20), respectively,

\tilde{H}_{q}X*_{q}+X*_{q}\tilde{H}_{q}^{T}+E₁δ₁²E₁^{T}=0 (19)

\tilde{G}_{q}^{T}Y*_{q}+Y*_{q}\tilde{G}_{q}+E₁β₁²E₁^{T}=0 (20)

then

(A−Δ₁)P_{q}+P_{q}(A−Δ₁)^{T}+RR^{T}=0 (21)

(A−Δ₂)^{T}Q_{q}+Q_{q}(A−Δ₂)+L^{T}L=0 (22)

After substitution of X_{q}=X*_{q} into equation (17), a result is given as follows:

$$A ( {𝒱}_{g , q} {X}_{q}^{*} {𝒱}_{g , q}^{T} ) + ( {𝒱}_{g , q} {X}_{q}^{*} {𝒱}_{g , q}^{T} ) {A}^{T} + R {R}^{T} = ( I - {{𝒱}_{g , q} ( {𝒲}_{g , q}^{T} {𝒱}_{g , q} )}^{- 1} {𝒲}_{g , q}^{T} ) {V}_{q + 1} {E}_{q}^{T} {X}_{q}^{*} {𝒱}_{g , q}^{T} + {𝒱}_{g , q} {X}_{q}^{*} {E}_{q} {β}_{q + 1} {{V}_{q + 1}^{T} ( I - {{𝒱}_{g , q} ( {𝒲}_{g , q}^{T} {𝒱}_{g , q} )}^{- 1} {𝒲}_{g , q}^{T} )}^{T}$$

(W_{g,q}^{T}V_{g,q})⁻¹W_{g,q}^{T}V_{g,q}=I, namely E_{q}^{T}(W_{g,q}^{T}V_{g,q})⁻¹W_{g,q}^{T}V_{g,q}=E_{q}^{T}, so a result is given as follows:

$${R}_{q} ( {X}_{q}^{*} ) = ( I - {{𝒱}_{g , q} ( {𝒲}_{g , q}^{T} {𝒱}_{g , q} )}^{- 1} {𝒲}_{g , q}^{T} ) {V}_{q + 1} {δ}_{q + 1} {{E}_{q}^{T} ( {𝒲}_{g , q}^{T} {𝒱}_{g , q} )}^{- 1} {𝒲}_{g , q}^{T} ( {𝒱}_{q} {X}_{q}^{*} {𝒱}_{g , q}^{T} ) + ( {𝒱}_{q} {X}_{q}^{*} {𝒱}_{g , q}^{T} ) {( {𝒲}_{g , q}^{T} {𝒱}_{g , q} )}^{- 1} {𝒲}_{g , q}^{T} {E}_{q} {δ}_{q + 1} {{V}_{q + 1}^{T} ( I - {{𝒱}_{g , q} ( {𝒲}_{g , q}^{T} {𝒱}_{g , q} )}^{- 1} {𝒲}_{g , q}^{T} )}^{T}$$

The equations are re-arranged and then Δ₁=(I−V_{g,q}(W_{g,q}^{T}V_{g,q})⁻¹W_{g,q}^{T})V_{q+1}δ_{q+1}E_{q}^{T}(W_{g,q}^{T}V_{g,q})⁻¹W_{g,p}^{T}.

Likewise, after substitution of Y_{q}=Y*_{q} in equation (22) into equation (18), a result is given as follows:

$${A}^{T} ( {𝒲}_{g , q} {Y}_{q}^{*} {𝒲}_{g , q}^{T} ) + ( {𝒲}_{g , q} {Y}_{q}^{*} {𝒲}_{g , q}^{T} ) A + {L}^{T} L = ( I - {{𝒲}_{g , q} ( {𝒱}_{g , q}^{T} 𝒲 )}^{- 1} {𝒱}_{g , q} ) {W}_{q + 1} {β}_{q + 1} {E}_{q}^{T} {Y}_{q}^{*} {𝒲}_{g , q}^{T} + {𝒲}_{g , q} {Y}_{q}^{*} {E}_{q} {β}_{q + 1} {W}_{q + 1}^{T} ( I - {{𝒱}_{g , q} ( {𝒲}_{g , q}^{T} {𝒱}_{g , q} )}^{- 1} {𝒲}_{g , q}^{T} )$$

In case of E_{q}^{T}(V_{g,q}^{T}W_{g,q})⁻¹V_{g,q}^{T}W_{g,q}=E_{q}^{T}, then

$${S}_{q} ( {Y}_{q}^{*} ) = ( I - {{𝒲}_{g , q} ( {𝒱}_{g , q}^{T} {𝒲}_{g , q} )}^{- 1} {𝒱}_{g , q} ) {W}_{q + 1} {β}_{q + 1} {{E}_{q}^{T} ( {𝒱}_{g , q} {𝒲}_{g , q} )}^{- 1} {𝒱}_{g , q}^{T} ( {𝒲}_{g , q} {Y}_{q}^{*} {𝒲}_{g , q}^{T} ) + ( {𝒲}_{g , q} {Y}_{q}^{*} {𝒲}_{g , q}^{T} ) {{𝒱}_{g , q} ( {𝒲}_{g , q}^{T} {𝒱}_{g , q} )}^{- 1} {E}_{q} {β}_{q + 1} {W}_{q + 1}^{T} ( I - {{𝒱}_{g , q} ( {𝒲}_{g , q}^{T} {𝒱}_{g , q} )}^{- 1} {𝒲}_{g , q}^{T} )$$

Thus, Δ₂=V_{g,q}(W_{g,q}^{T}V_{g,q})⁻¹E_{q}β_{q+1}W_{q+1}^{T}(I−V_{g,q}(W_{g,q}^{T}V_{g,q})⁻¹W_{g,q}^{T}).

It is proposed in this invention that Δ=Δ₁+Δ₂ is substituted into the Lyapunov equation to satisfy:

(A−Δ)P_{q}+P_{q}(A−Δ)^{T}+RR^{T}=0 (23)

(A−Δ)^{T}Q_{q}+Q_{q}(A−Δ)+L^{T}L=0 (24)

where the rank of Δ at most is 2, which may be expressed as:

$$\begin{matrix}Δ = [ {𝒱}_{g , q} {E}_{q} ( I - {{𝒱}_{g , q} ( {𝒲}_{g , q}^{T} {𝒱}_{g , q} )}^{- 1} {𝒲}_{g , q}^{T} ) {V}_{q + 1} ] \\ [ \begin{matrix}0 & {β}_{q + 1} \\ {δ}_{q + 1} & 0\end{matrix} ] [ \begin{matrix}{E}_{q}^{T} {𝒲}_{g , q}^{T} \\ {W}_{q + 1}^{T} ( I - {{𝒱}_{g , q} ( {𝒲}_{g , q}^{T} {𝒱}_{g , q} )}^{- 1} {𝒲}_{g , q}^{T} )\end{matrix} ]\end{matrix} \qquad ( 25 )$$

In consideration of the system, if the perturbation system is added to equations (23) and (24), then

$$( A - Δ ) \frac{d {x}_{Δ} ( t )}{d t} = {x}_{Δ} ( t ) - Ru ( t ) and y ( t ) {Lx}_{Δ} ( t ) \qquad ( 26 )$$

where from

$$\begin{matrix}\begin{matrix}Δ = [ {𝒱}_{g , q} {E}_{q} ( I - {{𝒱}_{g , q} ( {𝒲}_{g , q}^{T} {𝒱}_{g , q} )}^{- 1} {𝒲}_{g , q}^{T} ) {V}_{q + 1} ] \\ [ \begin{matrix}0 & {β}_{q + 1} \\ {δ}_{q + 1} & 0\end{matrix} ]\end{matrix} \\ [ \begin{matrix}{E}_{q}^{T} {𝒲}_{g , q}^{T} \\ {W}_{q + 1}^{T} ( I - {{𝒱}_{g , q} ( {𝒲}_{g , q}^{T} {𝒱}_{g , q} )}^{- 1} {𝒲}_{g , q}^{T} )\end{matrix} ] ,\end{matrix}$$

the transfer matrix H₆₆(s₀+σ) of the original system extra provided with the perturbation system is equal to the transfer matrix Ĥ(s₀+σ) of the reduced system. Because of the definition of Δ in equation (25), a result is given as follows:

\tilde{W}_{g,q}^{T}(I−V_{g,q}(W_{g,q}^{T}V_{g,q})⁻¹W_{g,q}^{T})=0_{□}(I−V_{g,q}(W_{g,q}^{T}V_{g,q})⁻¹W_{g,q}^{T})V_{g,q}=0

thus

$${\tilde{𝒲}}_{g , q}^{T} {Δ𝒱}_{g , q} = [ {E}_{q} 0 ] [ \begin{matrix}0 & {β}_{q + 1} \\ {δ}_{q + 1} & 0\end{matrix} ] [ \begin{matrix}{E}_{q}^{T} {𝒲}_{g , q}^{T} {𝒱}_{g , q} \\ 0\end{matrix} ] = 0$$

Thus, \tilde{W}_{g,q}^{T}(A−Δ)V_{g,q}=\tilde{W}_{g,q}^{T}AV_{g,q}, namely Â=\tilde{W}_{g,q}^{T}(A−Δ)V_{g,q}. V_{g,q} is multiplied at the left side of the equation, and then V_{g,q}Â=V_{g,q}\tilde{W}_{g,q}^{T}(A−Δ)V_{g,q}. In case of V_{g,q} ε colspan{V_{g,q}}, then

V_{g,q}Â=(A−Δ)V_{g,q}

−σ is multiplied and then V_{g,q} is added, and the equation may be changed into:

(Iₙ−σ(A−Δ₁))⁻¹V_{g,q}=V_{g,q}(I_{qs}−σÂ)⁻¹

Finally, L is multiplied at the left side of the equation, while \tilde{W}_{g,q}^{T}R is multiplied at the right side of the equation; after mathematic operation, a result is given as follows:

L(Iₙ−σ(A−Δ))⁻¹V_{g,q}\tilde{W}_{g,q}^{T}R=LV_{g,q}(I_{qs}−σÂ)⁻¹\tilde{W}_{g,q}^{T}R_{□}

R ε colspan{V_{g,q}}, V_{g,q}\tilde{W}_{g,q}^{T}R=R, so the equation may be changed into:

L(Iₙ−σ(A−Δ))⁻¹R=\hat{L}(I_{qs}−σÂ)⁻¹\hat{R}

Then,

Ĥ(s₀+σ)=H_{Δ}(s₀+σ) (27)

Thus, it proves that the output transfer function of the declining order system is equal to that of the original system additionally provided with turbulence.

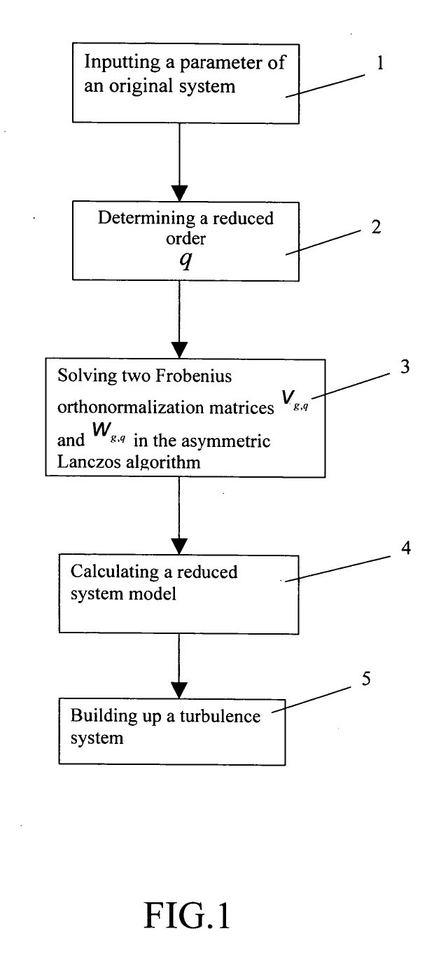

For the process of this invention, refer to the flow shown in FIG. 1.

Parameters of the original system that are inputted at step 1 are parameters for passive components that are inputted in the original circuit, in which a matrix

$$M = [ \begin{matrix}C & 0 \\ 0 & L\end{matrix} ]$$

comprises capacitance C and inductance L in a circuit, and a matrix

$$N = [ \begin{matrix}0 & E \\ - {E}^{T} & R\end{matrix} ]$$

comprises resistance R and an incidence matrix E, and a corresponding modified nodal analysis equation is constructed;

at step 2, determining the reduced order q: the declining system is generated in a projection skill applied for the original circuit and the reduced order q is determined;

at step 3, solving the Frobenius orthonormalization matrices V_{g,q} and W_{g,q} in the asymmetric Lanczos algorithm: in the global asymmetric Lanczos algorithm, q times of iteration is executed for the Frobenius orthonormalization matrices V_{g,q} and W_{g,q};

at step 4, calculating the reduced system model: the reduced system is constructed through the two matrices, and the union of the preceding 2q orders of the reduced system is identical to the union of original system; and

finally, at step 5, building up the turbulence system: the turbulence system Δ is applied, and it may be verified that the output transfer function of reduced system is equal to that of original system additionally provided with the perturbation system, Ĥ(s₀+σ)=H_{Δ}(s₀+σ).

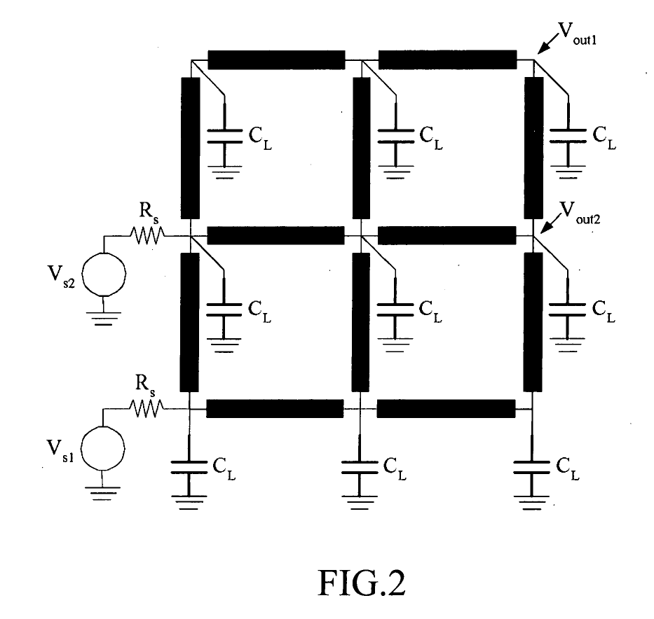

In this invention, a simple embodiment is used as a test case for verification of the accuracy of algorithm, as shown in FIG. 2 illustrating a RLC circuit provided with 12 lines of which the parameters are a resistor of 1.0 Ω/cm, a capacitor of 1.0 pF/cm, an inductor of 1.5 nH/cm, a drive resistor of 3Ω, and a load capacitor of 1.0 pF, respectively. Each line is 50 mm long and divided into 20 pieces.

Thus, there are 237 nodes, 240 branches, and dimension n=477 of MNA matrix in branching lines. In the simple embodiment, two input voltage sources and two output receiving terminals are included. They are s=2 and s=2. In this embodiment, an operating frequency range is {0,15 GH_{z}}, and a frequency expansion point of reduced system is made to be s₀=0 H_{z}. The order of reduced system is set to 7 and thus the determined order of reduced system is qs=14.

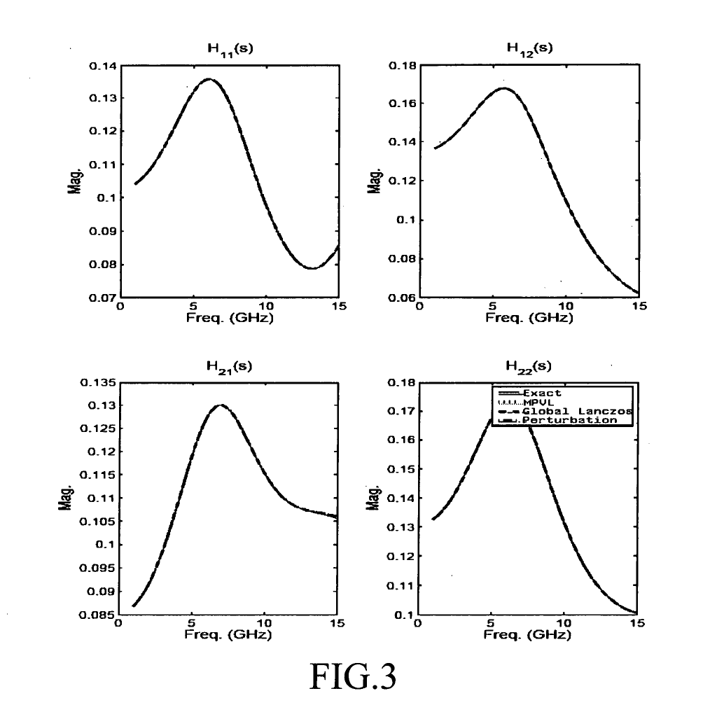

Next, FIG. 3 shows a simulation result in the embodiment, in which H(s) stands for an original system, Ĥ_{g}(s) is a transfer function of reduced system in the global Lanczos algorithm, Ĥ_{b}(s) is a transfer function of reduced system in the MPVL algorithm of prior art, and H_{Δ}(s) is a transfer function of original system plus the turbulence matrix. Further, Hᵢⱼ(s) indicates an input source i and a transfer function given from output receiving end j.

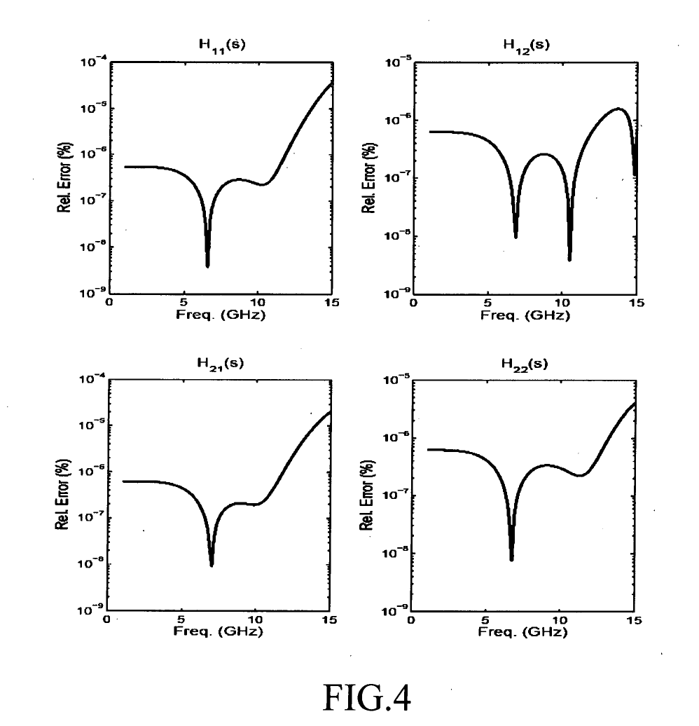

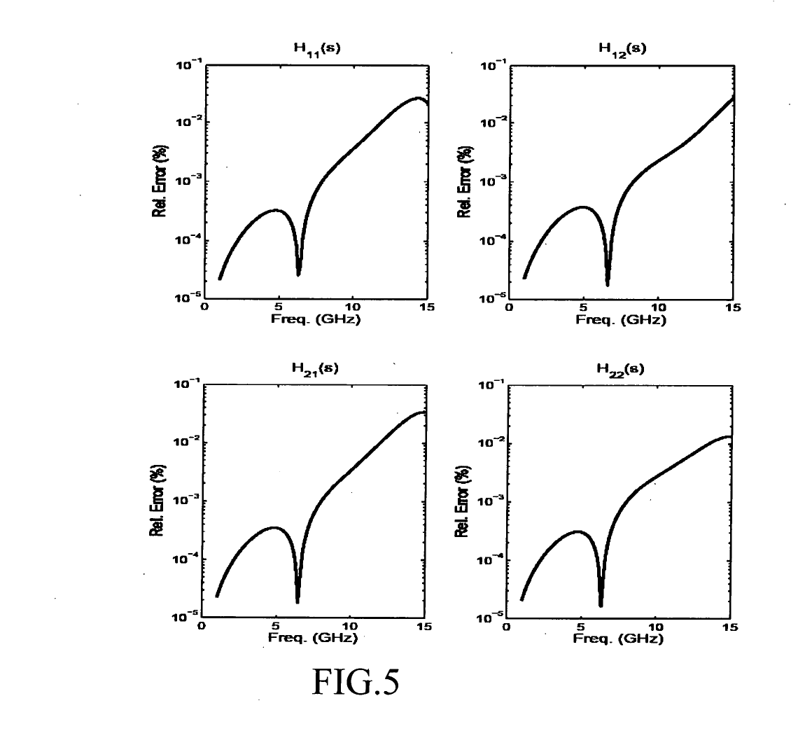

In FIG. 3, it is observed that the transfer matrix of reduced system and the original system matching are corresponding at a frequency expansion point, and FIG. 4 shows the relevant error between the two reduced systems. Finally, FIG. 5 shows the relevant error between the transfer function in the global Lanczos algorithm and the original system to which the turbulence system is added, from which the accuracy of equation (27) may be verified.

In this invention, a technology of reducing a MIMO circuit, the applied algorithm is the global Lanczos algorithm, and a congruent projection matrix is used to generate the reduced system so that the system union of preceding 2q system of the reduced system may be surely corresponding to that of original system. Also in this invention, the mathematic model of system union of order 2q+1 of the reduced system is proposed. In the Lyapunov equation as the model reduction art, the turbulence matrix Δ may be given in this invention, which is a mathematic model of which the rank at most is 2. The turbulence matrix comprises only the previous two Frobenius orthonormalization vectors in the global asymmetric PVL algorithm, so less calculation process is required. In this invention, it is proposed that the transfer function of reduced model in the algorithm is completely identical to that of original system additionally provided with the perturbation system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of reducing a multiple-inputs multiple-outputs (MIMO) interconnect circuit system in a global Lanczos algorithm, comprising the steps of:
(a) inputting a net-shaped circuit;
(b) inputting a frequency expansion point;
(c) building up a state-space matrix for a circuit;
(d) determining the reduced model order;
(e) generating Frobenius orthonormalization matrix V_{q} and W_{q} in the global Lanczos algorithm;
(f) building up a reduced model system; and
(g) building up a mathematical model for a perturbation system.

2. The method of reducing the MIMO interconnect circuit system in the global Lanczos algorithm according to claim 1, wherein the system union of the preceding 2q order of the reduced system is identical to the system union of original system, namely in case of j=0,1, . . . ,2q−1, \hat{L}Â^{j}\hat{R}=LA^{j}R.

3. The method of reducing the MIMO interconnect circuit system in the global Lanczos algorithm according to claim 1, wherein the mathematic model of system union of order 2q+1 of the reduced model system is:
LA^{2q}R=LA^{q}A^{q}R=β₁E₁^{T}W_{g,q}^{T}A^{2q}V_{g,q}E₁δ₁=β₁(E₁^{T}\tilde{T}_{g,q}^{q}W_{g,q}^{T}+(β₂β₃ . . . β_{q+1})Wq+1^{T})(V_{g,q}\tilde{T}_{g,q}^{q}E₁+(δ₂δ₃ . . . δ_{q+1})V_{q+1})δ₁
and the error model proposed in this invention is:
LA^{2q}R−\hat{L}Â^{2q}R=(β₁β₂ . . . β_{q+1}δ₁δ₂ . . . δ_{q+1})W_{q+1}^{T}V_{q+1}+β₁(δ₁δ₂δ₂ . . . δ_{q+1})E₁^{T}\tilde{T}_{g,q}^{q}W_{g,q}^{T}V_{q+1}+δ₁(β₁β₂β₂ . . . β_{q+1})W_{q+1}^{T}V_{g,q}\tilde{T}_{g,q}^{q}E_{□}

4. The method of reducing the MIMO interconnect circuit system in the global Lanczos algorithm according to claim 1, whereinthe perturbation system is added to serve as the perturbation of additive property for the transfer function H(s) of original circuit, and the transfer function H_{Δ}(s) of a corrective nodal analysis may be indicated below as:
$$A \frac{d {x}_{Δ} ( t )}{d t} = {x}_{Δ} ( t ) + Ru ( t )$$
and y(t)=Cx_{Δ}(t) where
$$Δ = [ {𝒱}_{g , q} {E}_{q} ( I - {{𝒱}_{g , q} ( {𝒲}_{g , q}^{T} {𝒱}_{g , q} )}^{- 1} {𝒲}_{g , q}^{T} ) {V}_{q + 1} ] [ \begin{matrix}0 & {β}_{q + 1} \\ {δ}_{q + 1} & 0\end{matrix} ] [ \begin{matrix}{E}_{q}^{T} {𝒲}_{g , q}^{T} \\ {W}_{q + 1}^{T} ( I - {{𝒱}_{g , q} ( {𝒲}_{g , q}^{T} {𝒱}_{g , q} )}^{- 1} {𝒲}_{g , q}^{T} )\end{matrix} ] ,$$
which is a matrix of rank “2”, and q is a reduced model order in the global Lanczos algorithm, β and δ may be given in the process of operation of the reduced system, and thus the output transfer function Ĥ(s) of reduced system is equal to that H_{Δ}(S) of original system additionally provided with the perturbation system.
